(19) United States
(12) Patent Application Publication
(10) Pub. No.: US 2005/0136230 A1
(43) Pub. Date: Jun. 23, 2005

(54) Laminate sheet and lamination method

(75) Inventor: Yasuto Kimura, Wakayama-shi (JP)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(73) Assignee: Noritsu Koki Co., Ltd.

(21) Appl. No.: 11/029,600

(22) Filed: Dec. 13, 2004

(30) Foreign Application Priority Data
Dec. 18, 2003 (JP) 2003-421121

(51) Int. Cl. B32B 5/16

(52) U.S. Cl. 428/204

(57) ABSTRACT

A laminate sheet for giving gloss finish to an image layer that is formed on a printing surface of a substrate by squirting small jets of ink in tiny droplets onto the substrate is provided. The laminate sheet includes a seal layer being transparent and laminated on the image layer, and a gloss layer being transparent and laminated on the seal layer. The seal layer exhibits stickiness to the image layer at least when the seal layer is laminated to the image layer, and is designed to be flexibly deformed so as to conform to a surface configuration of the image layer. The gloss layer has at least one of the opposite surfaces smoothly finished and has such a degree of stiffness as not to allow itself to be deformed due to deformation of the seal layer. The thus structured laminate can keep its smooth surface and give gloss finish to the image layer without an influence of an uneven surface of the image layer.

### CROSS REFERENCE TO RELATED APPLICATION

This application claims priority from Japanese Patent Application No. 2003-421121, which is incorporated herein by reference.

### BACKGROUND OF THE INVENTION

1. Field of the Invention

The present invention relates to a laminate sheet and a lamination method for giving gloss finish to an image layer that is formed on a surface of a substrate such as paper by squirting small jets of ink as tiny droplets onto the substrate.

2. Related Art

According to the remarkable improvement in performance of an inkjet printer, which results in production of a high quality image by the inkjet printer, an increased number of inkjet printers have been used in a photo processing field where it is required to produce an image with high quality.

The inkjet printer is designed to print an image or form an image layer on a paper by squirting small jets of ink thereto as tiny droplets from a print head. Herein, by “paper” is meant a general paper, a semi-gloss paper, a gloss paper, etc. Ink is likely to blur on a general paper such as a paper for PPC, and therefore a semi-gloss paper or a gloss paper, each forming an ink absorbing layer, is used in the photo processing field where it is required to produce an image with high quality.

Dye ink, pigment ink, and the like are available for use in printing by an inkjet printer. In the photo processing field, pigment ink is generally used for improved light stability.

There are cases where gloss finish must be given to an image formed on a surface of a substrate. Particularly, a demand for giving gloss finish is frequently made in the photo processing field.

In a case where an image is printed on a semi-gloss paper or a gloss paper with pigment ink, pigment particles contained in the ink are hard to be absorbed into an ink absorbing layer of the paper, causing an uneven surface of an image layer and hence a problem of greatly decreasing gloss of the surface of the printing layer. This problem may also be caused in a case where a paper is printed with dye ink. Particularly in a case where a coated paper, a resin sheet or the like having a low water absorption capability is used as a substrate, ink droplets are raised above the surface of a printing layer when adhered. This causes a very uneven surface and hence greatly decreases gloss of the surface.

Conventionally, decrease in gloss of the surface or giving gloss finish to the printed image (or the formed image layer) are prevented by coating high gloss resin on the image layer or laminating a high gloss resin sheet to the image layer. Japanese Examined Patent Application Publication No. Hei-07-20759 discloses a print protecting member for restore gloss lost that comprises a release substrate of a soft thin sheet material and a transfer layer made mainly of a thermo-plastic resin laminated on the release substrate. Specifically, according to the disclosure of this prior reference, while having the transfer layer laminated on the image layer formed on a paper, the paper and the print protecting member are heated and bonded to each other by pressure, and-then the release substrate is released, thereby giving gloss finish to the surface.

In the above technique disclosed in the prior reference, the gloss resin, which has been applied on the image layer, is coated on the image layer with a substantially uniform thickness as conforming to the uneven surface of the image layer, with the result that the coated resin cannot compensate for the uneven surface of the image layer. This coated surface causes irregular reflection of light and therefore is hard to produce a satisfactory gloss.

Also, in an arrangement where a resin sheet is to be laminated on a paper, air bubbles are created between the surface of the image layer and the resin sheet due to uneven surface of the image layer. Accordingly, the quality of a printed image visually recognized through the resin sheet may be deteriorated. When the surface of the image layer is greatly roughened, another problem arises in addition to the creation of air bubbles. Specifically, the resin sheet is formed into an uneven surface configuration so that the surface of the resin sheet causes irregular reflection of light. As a result, it is hard to produce a satisfactory gloss.

According to the above prior reference, the transfer layer that is made of mainly a thermo-plastic resin and bonded to the image layer on the paper by the application of heat and pressure through the release substrate, which release substrate is very thin, soft and is to be finally released or peeled off. This release layer is likely to be deformed due to deformation of the transfer layer in conformity with the uneven surface of the image layer. Accordingly, the surface of the transfer layer, which is exposed upon the release or peeling-off of the release substrate, has an uneven surface configuration so that the surface of the transfer sheet causes irregular reflection of light. As a result, it is hard to produce a satisfactory gloss.

In consideration of the above problems, it is an object of the present invention to provide a laminate sheet and a lamination method that are capable of giving gloss finish to a visually recognized image of an image layer formed by squirting small jets of ink as tiny droplets onto a paper without being influenced by an uneven surface of the image layer.

### SUMMARY OF THE INVENTION

According to one aspect of the present invention, there is provided a laminate sheet for giving gloss finish to an image layer that is formed on a printing surface of a substrate by squirting small jets of ink in tiny droplets onto the substrate. The laminate sheet includes a seal layer being transparent and laminated on the image layer, and a gloss layer being transparent and laminated on the seal layer. The seal layer exhibits stickiness to the image layer at least when the seal layer is laminated to the image layer, and is designed to be flexibly deformed so as to conform to a surface configuration of the image layer. The gloss layer has at least one of the opposite surfaces smoothly finished and has such a degree of stiffness as not to allow itself to be deformed due to deformation of the seal layer. Herein, by “substrate” is meant any materials or members that are capable of forming thereon an image by small jets of ink squirted in tiny droplets thereon, such as a general paper, a semi-gloss paper, a gloss paper, a coating sheet, as well as a CD-ROM or the like having a label surface that can be printed by small jets of ink squirted in tiny droplets thereon. By “smooth” is meant an almost evenly finished appearance free of cavities or pits. By “smooth surface” is meant a flat surface smoothly finished or a gently curved surface smoothly finished. By “transparent” is meant having a transmittance through a corresponding layer or member of greater than 0% up to 100%.

The seal layer of the thus structured laminate sheet exhibits stickiness to the image layer at least when the seal layer is laminated to the image layer, and is designed to be flexibly deformed so as to conform to a surface configuration of the image layer. Accordingly, by applying pressure onto the substrate and the gloss layer while having the laminate sheet laminated on the substrate with the seal layer laminated to the image layer, the seal layer is deformed and tightly adhered to the image layer. Since the seal layer has stickiness, it is tightly adhered to the image layer via its own stickiness.

Since the gloss layer has such a degree of stiffness so as not to allow itself to be deformed due to deformation of the seal layer in conformity with a surface configuration of the image layer, the gloss layer is unlikely to be influenced or deformed by the deformation of the seal layer and hence is kept in original shape and has a smooth surface remained unchanged. Whereby, gloss finish is given to an image, which can be visually recognized through the transparent seal layer and the transparent gloss layer, by the smooth surface of the gloss layer.

The seal layer may be made of a thermo-plastic resin that softens and exhibits stickiness and fluidity by application of heat, and the gloss layer may be made of a thermo-plastic resin that has a softening point higher than the softening point of the seal layer. With this arrangement, the seal layer can exhibit stickiness and fluidity by a heat treatment at a temperature lower than the softening point of the gloss layer but higher than the softening point of the seal layer so that the seal layer can tightly be bonded (adhered) to the surface of the image layer. On the other hand, even during this heat treatment, the gloss layer does not reach the softening point thereof and therefore is unlikely to be softened while keeping such a degree of stiffness as not to allow itself to be deformed due to deformation of the seal layer. Thus, the smooth surface of the gloss layer remains unchanged and therefore can give gloss finish to the image.

The seal layer, which exhibits stickiness when it has been heated, does not have stickiness at the ambient temperatures. This makes it possible to, for example, prepare the continuously formed laminate sheet and roll up the same without the fear that the seal layer is adhered to the gloss layer when they are laminated in rolled-up state, and thus smoothly pull out the laminate sheet from the roll.

The laminate sheet may further include a release layer that is releasably laminated on the surface of the gloss layer. Accordingly, when pressure is applied onto the substrate and the gloss layer with the laminate sheet laminated on the substrate, a pressing jig or the like does not directly contact the gloss layer, allowing for prevention of damages to the gloss layer. The release layer, which is releasable from the gloss layer, allows the undamaged or unscratched surface of the gloss layer to be exposed upon the release of the release layer therefrom. As a result, a high gloss image can be visually recognized.

According to another aspect of the present invention, there is provided a lamination method of laminating an image layer that is formed on a printing surface of a substrate by squirting small jets of ink in tiny droplets onto the substrate, thereby giving gloss finish to the image layer. The lamination method includes: laminating a laminate sheet to the substrate with a seal layer of the laminate sheet laminated on the image layer, the laminate sheet including the seal layer being transparent, exhibiting stickiness to the image layer and being designed to be flexibly deformed so as to conform to a surface configuration of the image layer and a gloss layer laminated to the seal layer, the gloss layer being transparent and having at least one of the opposite surfaces smoothly finished and has such a degree of stiffness as not to allow itself to be deformed due to deformation of the seal layer; and pressing the substrate and the laminate layer together by applying pressure onto the substrate and the gloss layer of the laminate sheet. Herein, by “substrate” is meant any materials or members that are capable of forming thereon an image by small jets of ink squirted in tiny droplets thereon, such as a general paper, a semi-gloss paper, a gloss paper, a coating sheet, as well as a CD-ROM or the like having a label surface that can be printed by small jets of ink squirted in tiny droplets thereon. By “smooth” is meant an almost evenly finished appearance free of cavities or pits. By “smooth surface” is meant a flat surface smoothly finished or a gently curved surface smoothly finished. By “transparent” is meant having a transmittance through a corresponding layer or member of greater than 0% up to 100%.

In the above lamination method, while having the laminate sheet laminated on the substrate in such a manner as to have the seal layer, which has stickiness to the image layer and is designed to be flexibly deformed so as to conform the surface configuration of the image layer, laminated on the image layer, pressure is applied onto the substrate and the gloss layer so that the seal layer is deformed and tightly adhered to the image layer.

Since the gloss layer has at least one of the opposite surfaces smoothly finished and has such a degree of stiffness so as not to allow itself to be deformed due to deformation of the seal layer in conformity with the surface configuration of the image layer, the gloss layer is unlikely to be influenced or deformed by the deformation of the seal layer and hence is kept in original shape and has a smooth surface remained unchanged. Whereby, gloss finish is given to an image, which can be visually recognized through the transparent seal layer and the transparent gloss layer, by the smooth surface of the gloss layer.

In the laminate method, the seal layer may be made of a thermo-plastic resin that softens and exhibits stickiness and fluidity by application of heat, and the gloss layer may be made of a thermo-plastic resin that has a softening point higher than the softening point of the seal layer. With this arrangement, the substrate and the laminate are transferred to a downstream side as being pressed together between a pair of heat rollers set at a temperature lower than the softening point of the gloss layer but higher than the softening point of the seal layer while applying pressure onto the substrate and the gloss layer.

With the above arrangement, the seal layer is softened and exhibits stickiness and fluidity upon the application of heat by the heat rollers. Therefore, by the tight contact with the heat rollers, the seal layer is flexibly deformed in conformity with the surface configuration of the image layer by the pressing force of the heat rollers, thereby allowing itself to be tightly adhered to the surface of the image layer. As an additional advantage, since the pressing portion by the heat rollers is continuously changed as the substrate with the laminate sheet laminated thereon is transferred by the heat rollers, air between the image layer and the seal layer is subsequently squeezed out. As a result, the seal layer is tightly adhered to the entire surface of the image layer. On the other hand, the gloss layer is kept in original condition or shape and its smooth surface remains unchanged so that gloss finish can be given to an image, which is visually recognizable through the seal layer and the gloss layer, by the smooth surface of the gloss layer.

According to the laminate sheet as described above, it is possible to produce an excellent effect, that is, give gloss finish to a visually recognized image without an influence of an uneven surface of the image layer which is formed by squirting small jets of ink as tiny droplets.

Further, according to the lamination method as described above, it is also possible to produce an excellent effect, that is, give gloss finish to a visually recognized image without an influence of an uneven surface of the image layer which is formed by squirting small jets of ink as tiny droplets.

### BRIEF DESCRIPTION OF THE DRAWINGS

The above, and other objects, features and advantages of the present invention will become apparent from the detailed description thereof in conjunction with the accompanying drawings wherein.

FIG. 1 is an enlarged, vertically cross sectional view of a part of a paper to be laminated by using a laminate sheet according to one embodiment of the present invention, in which an image has been already printed on the paper.

FIG. 2 is an enlarged, vertically cross sectional view of a part of the laminate sheet according to the one embodiment of the present invention.

FIG. 3 is an explanatory view for explaining a lamination method of laminating an image printed paper by using the laminate sheet of the one embodiment of the present invention.

FIGS. 4A and 4B are enlarged, vertically cross sectional views of a part of the image printed paper with the laminate sheet of the one embodiment laminated thereon. Specifically, FIG. 4A illustrates a state where a release layer is laminated with a gloss layer, while FIG. 4B illustrates a state where the release layer is being released or peeled off from the gloss layer.

### DETAILED DESCRIPTION OF THE PREFERRED EMBODIMENT

Now, the description will be made for a laminate sheet according to one embodiment of the present invention with reference to the drawings attached hereto.

A laminate sheet S according to this embodiment is designed to be adapted to be used in the photo processing field where it is required to produce an image with high quality. Specifically, the laminate sheet S of this embodiment is to give gloss finish to an image (an image layer) formed on a surface of a substrate or paper in this embodiment by squirting small jets of ink as tiny droplets onto the paper.

Prior to the description about the laminate sheet S of this embodiment, a brief explanation will be made for ink used for an inkjet printer and a paper to be printed by this ink.

As mentioned above, dye ink and pigment ink are available, while pigment ink is usually used in the photo processing field for improved light stability and thus achieving prevention of deterioration in printed image quality.

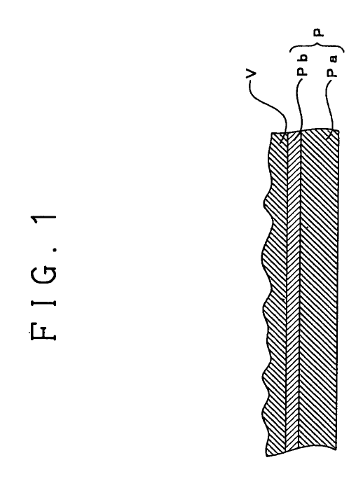

As a paper used in this embodiment, a semi-gloss paper or a gloss paper is used. Specifically, any one of the semi-gloss paper and the gloss paper includes a base Pa made of paper and an ink absorption layer Pb formed on a surface of the base Pa, as illustrated in FIG. 1. In this embodiment, the paper has a continuous form, that is, a web of paper so as to be cut into pieces having a predetermined length after being continuously laminated by the laminate sheet S for improved efficiency in processing.

The ink absorption layer Pb is designed to prevent ink blurring by efficiently absorbing ink applied thereon. That is, the ink absorption layer Pb has a large number of minute holes (not shown) for absorption so that ink applied on the surface is absorbed into the holes for improved absorption capability.

In general, the holes are smaller in diameter than the pigment particles contained in the ink, so that when small jets of the ink are squirted from a print head of the inkjet printer onto paper P having the above structure, as tiny droplets, the pigment of the ink squirted on the paper P is not absorbed into the holes but accumulated on the surface of the paper P (the ink absorption layer Pb). Thus, an image layer V formed by the squirted ink has an uneven surface configuration. For a portion of the image in white, the color (white) of the paper P is used and therefore there causes a height difference (stepped portions) between portions with no ink applied (white portions) and portions with ink applied.

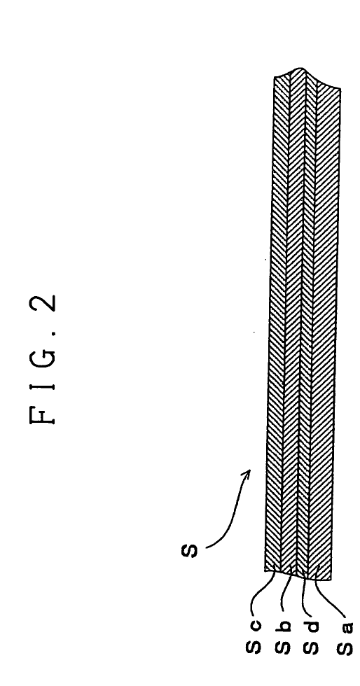

In order to laminate the paper P thus printed and hence given such uneven surface configuration, the laminate sheet S of this embodiment includes a seal layer Sa adapted to be laminated on the image layer V, a gloss layer Sb laminated on the seal layer Sa and a release layer Sc laminated on the gloss layer Sb for protection of the gloss layer Sb, as illustrated in FIG. 2.

The seal layer Sa is made of a thermoplastic resin that is softened by a heat treatment at a predetermined temperature (a softening point) or higher, thereby exhibiting stickiness and fluidity. A thermo-plastic resin employed for the seal layer Sa is transparent and preferably highly transparent. Specifically, a polyester resin having a softening point of 60° C.-100° C. is employed in this embodiment.

The gloss layer Sb has a smooth surface (an almost evenly finished surface free of cavities or pits), which is opposite to the surface tightly adhered to the seal layer Sa. The gloss layer Sb is made of a thermo-plastic resin having a softening point higher than the softening point of the seal layer Sa and being transparent or highly transparent. In this embodiment, an acrylic resin having a softening point of 100° C.-150° C. is employed. Whereby, the gloss layer Sb has such a degree of stiffness as not to be deformed due to deformation of the seal layer Sa, which deformation may occur when the seal layer Sa is softened at a temperature higher than the softening point of the seal layer Sa. That is, the gloss layer Sb has such a degree of stiffness as to allow itself to keep the original condition or shape and a smooth surface even if the seal layer Sa has been softened.

In this embodiment, a polyester resin is employed for the seal layer Sa, while an acrylic resin is employed for the gloss layer Sb. In order to secure the lamination (bonding) or increase the adhesion strength between these layers of different resins, an anchor coat layer Sd is interposed between the seal layer Sa and the gloss layer Sb. For the anchor coat layer Sd, a material having a high transparency in the same manner as the seal layer Sa and the gloss layer Sb is employed.

The release layer Sc is formed by molding polyethylene terephthalate (PET) resin into sheet, and bonded to the surface of the gloss layer Sb by its own stickiness so as to be able to be released from the gloss layer Sb without any matters or remnants such as a bonding agent left on the gloss layer Sb.

The thus structured laminate sheet S is fabricated by forming the gloss *4 layer Sb on a thin sheet, which forms the release layer Sc, to have a laminated structure, and then forming the seal layer Sa on the gloss layer Sb to have a further laminated structure. Specifically, in order to smoothen the surface of the gloss layer Sb, a sheet, which forms the release layer Sc, is placed on a smoothened top of a mold platen, and the gloss layer Sb, the anchor coat layer Sd and the seal layer Sa are laminated on the sheet of the release layer Sc in this order. During this lamination, the sheet of the release layer Sc acts as a substrate. Whereby, it is possible to form the gloss layer Sb with a smoothened surface exposed when the release layer Sc has been released from the gloss layer Sb. Needless to say, at least a surface of the sheet of the release layer Sc, to which the gloss layer Sb is laminated, is smoothened, while it is preferable to have both the surfaces smoothened.

The laminate sheet S has a continuous form so as to be capable of being continuously laminated on the printed paper P, and being rolled up for the purpose of convenient storage with the gloss layer Sb facing out. Hereinafter, the rolled laminate sheet S is referred to a roll R.

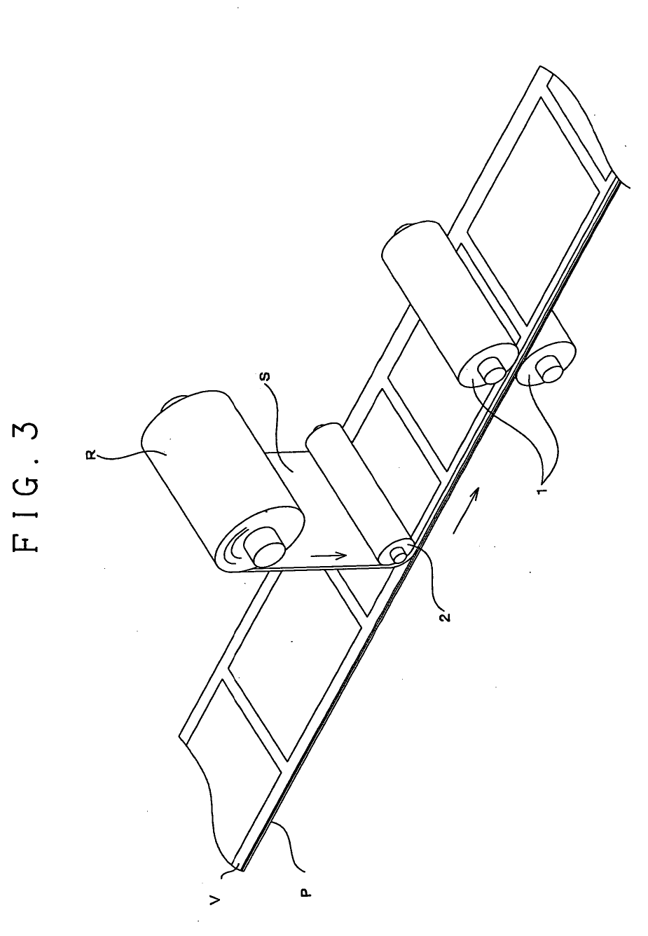

Now, the description will be made for the method of laminating the printed paper P by using the laminate sheet S. As illustrated in FIG. 3, the roll R is supported so as to be axially movable and set in position so as to allow the laminate sheet S to be pulled out from the roll R. The laminate sheet S pulled out from the roll S is overlapped to the paper P. At this time, an image (the image layer V) printed on one side of the paper P faces the seal layer Sa of the laminate sheet S. In this embodiment, prior to being overlapped on the paper P, the laminate sheet S pulled out from the roll S is wound around a feeding-direction change roll 2 to change its feeding direction for proper overlapping to the paper P.

The laminate sheet S and the paper P are synchronously transferred in the lengthwise direction so as to keep the overlapped state and fed between a pair of heat rollers 1 disposed downstream to the roll R. The surfaces of the pair of heat rollers 1 are set at a temperature lower than the softening point of the gloss layer Sb (the temperature at which the gloss layer Sb is softened) but higher than the softening point of the seal layer Sa (the temperature at which the seal layer Sa is softened) so that only the seal layer Sa is softened without softening the gloss layer Sb. In this embodiment, the temperature is set at 90° C.-140° C.

With the above arrangement, the laminate sheet S and the paper P, which have been overlapped to each other, are heated by the pair of rollers 1, thereby softening the seal layer Sa. Specifically, the release layer Sc and the gloss layer Sb of the laminate sheet S, the softening points of which being set higher than the softening point of the seal layer Sa, are not softened even when the laminate sheet 1 is heated by the heat rollers 1, so that only the seal layer Sa is softened and exhibits fluidity and stickiness.

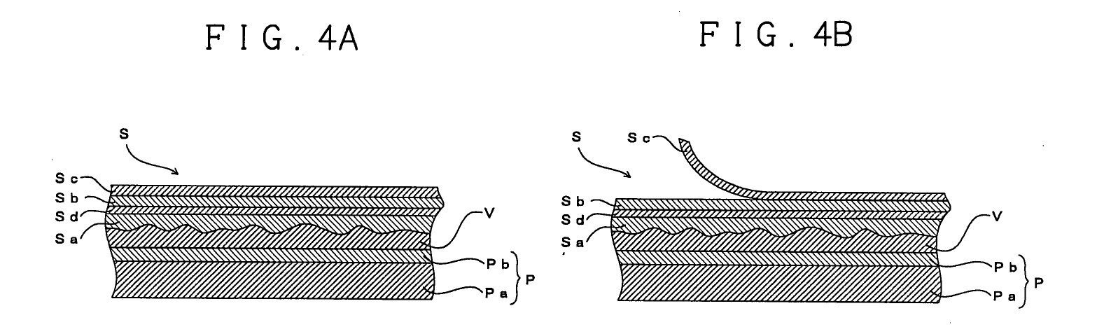

In the above state, the laminate sheet S and the paper P held in a laminated state are pressed between the pair of heat rollers 1 through their tight contact. Accordingly, as illustrated in FIG. 4A, the seal layer Sa is fluidized and deformed so as to conform to the surface configuration of the image layer V and thus tightly adhered to the image layer V. With the pair of heat rollers 1 held in tight contact with the laminate sheet S and paper P overlapped to each other, the pressing portion by the heat rollers 1 is continuously changed as they are transferred by the pair of heat rollers 1, so that air between the image layer V and the seal layer Sa is squeezed out. As a result, the seal layer Sa is adhered to the entire surface of the image layer V in tight contact with each other. At this time, the gloss layer Sb is not softened, and hence keeps its stiffness that is large enough not to be influenced by the deformation of the seal layer Sa. As a result, the gloss layer Sb keeps its original condition or shape and the smoothened surface.

The thus formed laminate of the laminate sheet S and the paper P is cut into pieces having a predetermined length corresponding to the respective image forming regions of the paper P after the seal layer Sa has been hardened, so as not to cause the seal layer Sa and the image layer V to be displaced from each other. Then, as illustrated in FIG. 4B, the release layer Sc is peeled off to expose the smoothened surface of the gloss layer Sb so that the image (image layer V) with gloss finish can be visually recognized through the seal layer Sa and the gloss layer Sb. The release layer Sc adheres to the gloss layer Sb by its own stickiness. Therefore, when the release layer Sc has been peeled off from the surface of the gloss layer Sb, matters or remnants are not left thereon, unlike the case where they are bonded together via an adhesive.

As described above, according to the laminate sheet of this embodiment, it possesses stickiness to the image layer V formed on the paper P, and the gloss layer Sb, which has such a degree of stiffness as not to be influenced by the deformation of the seal layer Sa, is laminated on the seal layer Sa capable of being flexibly deformed in conformity with the surface configuration of the image layer V. Thus, at the time of making the seal layer Sa adhere to the image layer V, the gloss layer Sb can keep its smoothened surface even if the seal layer Sa is deformed in conformity with the surface configuration of the image layer V. As a result, it is possible to give gloss finish to the image layer V regardless of the uneven surface of the image layer V, which gloss finish is satisfactory even in the photo processing field where it is requested to produce an image with high quality.

A polyester resin employed for the seal layer Sa exhibits stickiness and fluidity when it has been heated, and therefore the seal layer Sa does not have stickiness and fluidity at the ambient temperatures. This makes it possible to roll up the laminate sheet S for storage in the form of the roll R without the possibility that the seal layer Sa adheres to the release layer Sc and thus smoothly pull out the laminate sheet S from the roll R.

The release layer Sc, which is peelably or releasably laminated on the gloss layer Sb, can prevent direct contact between the surface of the gloss layer Sb and the heat rollers 1 and thus prevent the surface of the gloss layer Sb from being damaged or scratched by the tight contact with the heat rollers 1. Once the release layer Sc is peeled off from the gloss layer Sb, the exposed surface remains undamaged or unscratched and therefore is glossy, so that a fine gloss finish can be given to an image printed on the paper P.

The printed paper P and the laminate sheet S overlapped to each other are then pressed between the heat rollers 1 so that the softened seal layer Sa can be deformed to exactly conform the surface configuration of the image layer V with pressure. The heat rollers 1, which together press the overlapped laminate sheet and paper P therebetween, can securely squeeze out air left between the seal layer Sa and the image layer V as these laminated layers are subjected to the pressure from the heat rollers 1. Thus, the seal layer Sa is more tightly adhered to the image layer V.

It is a matter of course that the present invention is not necessarily limited to this embodiment, and therefore various modifications can be made within the scope of the present invention.

While in the above embodiment, a thermoplastic resin (polyester resin) is employed for the seal layer Sa, the material of the seal layer Sa is not necessarily limited thereto. For example, it is possible to employ a blend of acrylic resin and cellulose.

In the above embodiment, the release layer Sc is adapted to be adhered to the gloss layer Sb by its own stickiness. However, the present invention is not necessarily limited to this. For example, where the release layer Sc exhibits a high degree of stickiness to the gloss layer Sb when they are laminated together, a release coat layer may be formed on an adhesive surface (a laminating surface) of the release layer Sc for providing a proper adhesive strength to the gloss layer Sb. This release coat layer is preferably made of silicone resin, fluorinated resin or the like having a softening point of 200° C.-250° C. This release coat layer tightly adhered to the release layer Sc via the high degree of stickiness of the release layer Sc provides a satisfactory stickiness allowing the release layer Sc to be securely peeled off along with the release coat layer from the gloss layer Sb without remnants left on the surface of the gloss layer Sb.

In the above embodiment, the anchor coat layer Sd is interposed between the seal layer Sa and the gloss layer Sb in order to increase the bonding strength therebetween. Alternatively, the gloss layer Sb may be adhered to the seal layer Sa by its own stickiness. That is, whether the anchor coat layer Sd is provided or not may depend on the bonding strength between the seal layer Sa and the gloss layer Sb, which may be varied depending on the materials used for these layers.

In the above embodiment, the seal layer Sa exhibits stickiness and fluidity when heated for compensating the uneven surface of the image layer V. The present invention is not necessarily limited to this. For example, the compensation for the uneven surface of the image layer V may be achieved by employing an adhesive that has a high transparency and is designed to exhibit stickiness and flexibility at the ambient temperatures and cured after being adhered to an object surface. In this case, it is a matter of course that the gloss layer Sb has such a degree of stiffness as not to be deformed due to the deformation of the seal layer Sb in conformity with the surface configuration of the image layer V. This arrangement omits the necessity to heat and soften the seal layer Sa and hence allows the heat rollers 1 to be replaced with general rollers having no heating function.

In the above embodiment, the pair of rollers 1 are employed to continuously press the laminate sheet S and the printed paper S overlapped to each other as they are transferred. The present invention is not necessarily limited to this arrangement. For example, a pair of plates or dies having smooth pressing surfaces may be employed so that the laminate sheet S and the printed paper overlapped to each other are pressed therebetween. In such an arrangement, the laminate sheet S and the print P, which have a continuous form, are not continuously but intermittently pressed unlike the case where the rollers together press these continuously formed sheet and print. Therefore, it is preferable to apply pressure onto the overlapped sheet and paper by the pair of rollers during they are transferred, in order to continuously and constantly apply pressure in the lengthwise direction of the overlapped and transferred laminate sheet and paper, in the same manner as the above embodiment.

In the above embodiment, the release layer Sc is laminated on the gloss layer Sb. The present invention is not necessarily limited to this arrangement. The release layer Sa may be omitted. That is, the gloss layer Sb is designed to have a softening point higher than that of the seal layer Sa and be capable of constantly keep a smooth surface, and the seal layer Sa is laminated to this gloss layer Sb. In other words, the gloss layer Sb simultaneously acts as a substrate of the laminate sheet S. Accordingly, when they are pressed, a heat roller, die or other pressing member directly contacts the smooth surface of the gloss layer Sb. It is preferable to provide a protective film or material on the pressing surface of the roller, die or other pressing member in order to prevent the surface of the gloss layer Sb from being scratched or damaged by the pressing surface of the roller, die or other pressing member. However, this protective film or member provided to the pressing member is unlikely to perfectly omit the possibility to scratch or damage the surface of the gloss layer Sb. In consideration of this possibility, it is preferable to releasably or peelably laminate the release layer Sc on the gloss layer Sb in the same manner as the above embodiment.

The above embodiment was described by taking for example the case where pigment ink in tiny droplets is used to form the image layer V on a paper (semi-gloss paper or gloss paper). The present invention is not necessarily limited to this. For example, dye ink in tiny droplets may be used to form the image layer V, on which the laminate sheet S is laminated. This arrangement can also give gloss finish to the image in the same manner as the above embodiment.

In the above embodiment, the laminate sheet S has a continuous form so as to be uninterruptedly laminated to the continuous paper P. The present invention is not necessarily limited to this. It is possible to employ a manner of processing where the paper with the image layer formed thereon is cut into pieces having a predetermined length; the laminate sheet S is also cut into pieces having the same length as that of the pieces of the paper P; the pieces of the paper P are respectively overlapped on the pieces of the laminate sheet S, while having the seal layer Sa laminated on the image layer V, as described above; and the paper P and the laminate sheet S are pressed between the rollers or other pressing members.

The above embodiment was described by taking for example the case where the paper P with the image layer V formed thereon is laminated. The present invention is not necessarily limited to this. That is, an object to be printed or substrate is not limited to a paper. Various objects may be subjected to the lamination of the present invention, such as a CD-ROM with a surface adapted to be printed by ink squirted in tiny drops thereon. An image layer formed on the surface of such a substrate also has an uneven surface with ink raised above the surface. Accordingly, it is possible to give gloss finish to a label or image by laminating the laminate sheet S to the surface of the image layer. The paper P is also not necessarily limited to a sub-gloss paper or gloss paper. A generally used paper or plain paper, a resin sheet, a coating sheet or the like may be used. That is, the laminate sheet and the lamination method of the present invention are broadly applied while not limited to specific objects to be printed or substrates, provided that gloss finish is required to be given to an image layer formed on a printing surface of the substrate.

This specification is by no means intended to restrict the present invention to the preferred embodiments set forth therein. Various modifications to the laminate sheet and the lamination method, as described herein, may be made by those skilled in the art without departing from the spirit and scope of the present invention as defined in the appended claims.

1. A laminate sheet for giving gloss finish to an image layer that is formed on a printing surface of a substrate by squirting small jets of ink in tiny droplets onto the substrate, comprising:
a seal layer being transparent and laminated on the image layer; and
a gloss layer being transparent and laminated on the seal layer; wherein
said seal layer exhibits stickiness to the image layer at least when the seal layer is laminated to the image layer;
said seal layer is designed to be flexibly deformed so as to conform to a surface configuration of the image layer; and
said gloss layer has at least one of the opposite surfaces smoothly finished and has such a degree of stiffness as not to allow itself to be deformed due to deformation of said seal layer.

2. The laminate sheet according to claim 1, wherein said seal layer is made of a thermo-plastic resin that softens and exhibits stickiness and fluidity by application of heat, and said gloss layer is made of a thermoplastic resin that has a softening point higher than the softening point of the seal layer.

3. The laminate sheet according to claim 1, further comprising a release layer that is releasably laminated on the surface of the gloss layer.

4. A lamination method of laminating an image layer that is formed on a printing surface of a substrate by squirting small jets of ink in tiny droplets onto the substrate, thereby giving gloss finish to said image layer, comprising:
laminating a laminate sheet to said substrate with a seal layer of the laminate sheet laminated on said image layer, said laminate sheet including said seal layer being transparent, exhibiting stickiness to the image layer and being designed to be flexibly deformed so as to conform to a surface configuration of the image layer and a gloss layer laminated to said seal layer, said gloss layer being transparent and having at least one of the opposite surfaces smoothly finished and has such a degree of stiffness as not to allow itself to be deformed due to deformation of said seal layer; and
pressing said substrate and said laminate layer together by applying pressure onto the substrate and the gloss layer of the laminate sheet.

5. The laminate method according to claim 4, wherein said seal layer is made of a thermo-plastic resin that softens and exhibits stickiness and fluidity by application of heat, and said gloss layer is made of a thermo-plastic resin that has a softening point higher than the softening point of the seal layer; and said substrate and said laminate are transferred to a downstream side as being pressed together between a pair of heat rollers set at a temperature lower than the softening point of the gloss layer but higher than the softening point of the seal layer while applying pressure onto the substrate and the gloss layer.
